(19) United States
(12) Patent Application Publication
(10) Pub. No.: US 2026/0234983 A1
(43) Pub. Date: Aug. 13, 2026

(54) REFRIGERATOR AND DOOR OPENING AND CLOSING DEVICE

(71) Applicants: LG Electronics Inc., Seoul (KR); Pusan National University Industry-University Cooperation Foundation, Busan (KR)

(72) Inventors: Jinho CHANG, Seoul (KR); Heejun LEE, Seoul (KR); Sanghu PARK, Busan (KR); Yoongho JUNG, Busan (KR)

(21) Appl. No.: 19/532,104

(22) Filed: Feb. 6, 2026

(30) Foreign Application Priority Data
Feb. 7, 2025 (KR) 10-2025-0015855

(51) Int. Cl. E05F 15/63; F25D 23/02

(52) U.S. Cl. CPC E05F 15/63; F25D 23/028; E05Y 2201/712; E05Y 2201/716; E05Y 2201/722; E05Y 2900/31; F25D 2323/02

(57) ABSTRACT

A refrigerator includes a cabinet, a door, and a door opening and closing device. The door opening and closing device includes: a driver that generates power, a power transmission portion that transmits the power of the driver, and an operating portion that receives the power of the driver and operates to open the door and including a link connected to the door. The power transmission portion includes: an input gear assembly configured to receive power from the driver, an output gear assembly configured to be connected to the input gear assembly to receive power from the input gear assembly when the driver is operated, and to be disconnected from the input gear assembly when the driver is stopped, and a rotation center of the input gear assembly and a rotation center of the output gear assembly are spaced apart from each other.

### CROSS-REFERENCE TO RELATED APPLICATIONS

The present application claims priority under 35 U.S.C. 119 to Korean Patent Application No. 10-2025-0015855, filed in the Republic of Korea on February 7, 2025, which is hereby incorporated by reference in its entirety.

### FIELD

The present disclosure relates to a refrigerator and a door opening and closing device.

### BACKGROUND

In general, a refrigerator is a home appliance for storing foods in an internal storage space, which is shielded by a door, at a low temperature by low temperature air.

The storage space is surrounded by an insulating wall so that an inside of the storage space is maintained at a temperature lower than an outside temperature. Depending on a temperature range of the storage space, the storage space may be called as a refrigerating chamber or a freezing chamber.

To put an object into or take the object out of the storage space, the user opens the door. Typically, the door is rotatably installed on the cabinet, and a gasket is provided between the door and the cabinet. Therefore, when the door is closed, the gasket seals tightly between the door and the cabinet, preventing cold air from leaking from the storage space. A greater a sealing force of this gasket, a greater an effect of preventing cold air from leaking.

To increase a sealing force of the gasket, the gasket may be formed of a rubber, and a magnet may be provided within the gasket. However, as the sealing force of the gasket increases, a greater force is required to open the door.

Accordingly, a refrigerator with automatic door opening functions have recently been introduced. A related prior art document is China Utility Model Registration No. 218324468.

### SUMMARY

One embodiment provides a refrigerator and a door opening and closing device that increases a door opening angle when the door is automatically opened.

Alternatively or additionally, one embodiment provides a refrigerator and a door opening and closing device that can automatically open and close the door.

Alternatively or additionally, one embodiment provides a refrigerator and a door opening and closing device in which the door can be opened automatically as well as manually by a user.

Alternatively or additionally, one embodiment provides a refrigerator and a door opening and closing device that prevents damage to a driver and allows the door to close smoothly when the user manually closes the door in a state in which the driver is stopped after operation.

Alternatively or additionally, one embodiment provides a refrigerator and a door opening and closing device in which damage to a driver for automatic opening is prevented when the door is manually opened.

A refrigerator according to one aspect may include a cabinet having a storage space; a door that opens and closes the storage space; and a door opening and closing device to open and close the door.

The door opening and closing device may include a driver that generates power, a power transmission portion that transmits the power of the driver, and an operating portion that receives the power of the driver and operates to open the door. The operating portion may include a link connected to the door.

The power transmission portion may include an input gear assembly to receive power from the driver. The input gear assembly may be referred to as an input unit.

The power transmission portion may include an output gear assembly configured to be connected to the input gear assembly to receive power from the input gear assembly when the driver is operated, and to be disconnected from the input gear assembly when the driver is stopped. The output gear assembly may also be referred to as an output unit. A rotation center of the input gear assembly and a rotation center of the output gear assembly may be spaced apart from each other.

The input gear assembly may include a shaft, a first input gear connected to the shaft and the driver, and a second input gear connected to the shaft. The first input gear may be referred to as an input gear, and the second input gear may be referred to as a clutch gear. A rotational direction of the second input gear may be opposite to a rotational direction of the output gear assembly.

The second input gear may be moved in an axial direction of the shaft when the first input gear is rotated.

The second input gear is located at an initial position when the driver is in a stopped state, and the second input gear may be disconnected from the output gear assembly at the initial position.

The second input gear may move in one direction along the shaft due to stationary inertia when the driver is operated in a forward direction, and may move in another direction opposite to the one direction along the shaft when the driver is operated in a reverse direction.

The shaft may include a screw or a worm gear to allow movement of the second input gear.

The second input gear may be directly coupled to the shaft, and a screw or a gear having a shape corresponding to the screw or the worm gear may be formed on the second input gear.

The second input gear may be connected to the shaft by a connection member, and a screw or a gear having a shape corresponding to the screw or the worm gear may be formed on the connection member.

The input gear assembly may further include: a first elastic member to restrict movement of the second input gear while the second input gear moves in the one direction when the driver is stopped during a reverse operation of the driver; and a second elastic member to restrict movement of the second input gear while the second input gear moves in the other direction when the driver is stopped during a forward operation of the driver.

The output gear assembly may include: a first output gear configured to be connected to the second input gear when the second input gear moves in the one direction; and a second output gear configured to be connected to the second input gear when the second input gear moves in the other direction.

When the second input gear is at the initial position, the second input gear may be disconnected from the first output gear and the second output gear.

The output gear assembly may include a connection portion connecting the first output gear and the second output gear. The first output gear and the second output gear may be rotated together.

The second input gear may include a plurality of gear teeth. A first inclined surface may be formed on a portion of each of the gear teeth facing the first output gear, and a second inclined surface may be formed on a portion of each of the gear teeth facing the second output gear.

An inclined surface may be formed on a portion of each of the gear teeth of the first output gear facing the first inclined surface. An inclined surface may be formed on a portion of each of the gear teeth of the second output gear facing the second inclined surface.

The second input gear may include a first gear portion connected to the shaft, and a second gear portion connected to the first gear portion and configured to be rotatable relative to the first gear portion.

The operating portion may include a first operating portion that operates by receiving power from the driver, and a second operating portion that operates by receiving power from the driver from the output gear and is positioned at a position spaced apart from a rotation center of the door. When the driver operates to automatically open the door, the first operating portion may start to operate, and the second operating portion may start to operate after the first operating portion starts to operate. The second operating portion may include the link.

According to another aspect, a door opening and closing device for opening and closing a door may include: a driver configured to generate power; a power transmission portion configured to transmit the power from the driver; and an operating portion configured to operate by receiving the power from the driver to open the door.

The operating portion may include: a first operating portion configured to operate by receiving power from the driver to open the door; and a second operating portion configured to operate by receiving power from the driver and having a link connected to the door.

The power transmission portion may include an input gear assembly.

The power transmission portion may further include an output gear assembly.

The output gear assembly may receive power from the input gear assembly and transmit the power to the second operating portion.

The input gear assembly may include a second input gear located at an initial position when the driver is in a stopped state, and configured to move to be connected to the output gear assembly when the driver is operated.

The input gear assembly may further include a shaft and a first input gear connected to the shaft and the driver. The second input gear may be configured to rotate together with the first input gear.

The second input gear may be connected to the shaft to be movable in an axial direction of the shaft.

The input gear assembly may transmit power to the output gear assembly in a direction crossing an axial direction of the shaft.

The output gear assembly may include: a first output gear configured to be connected to the second input gear when the driver is operated in a forward direction; and a second output gear configured to be connected to the second input gear when the driver is operated in a reverse direction.

The first output gear and the second output gear may rotate in a direction opposite to a rotational direction of the second input gear.

The first output gear and the second output gear may be rotated together in the same direction.

The input gear assembly may further include: a first elastic member to restrict movement of the second input gear while the second input gear moves in one direction when the driver is stopped during a reverse operation of the driver; and a second elastic member to restrict movement of the second input gear while the second input gear moves in the other direction when the driver is stopped during a forward operation of the driver.

According to one embodiment, there is an advantage in that an opening angle of the door is increased when the door is automatically opened.

According to an embodiment, there is an advantage in that the door can be not only automatically opened but also automatically closed.

According to an embodiment, there is an advantage in that the door can be not only automatically opened but also manually opened by a user.

According to an embodiment, when the driver stops after operating, a connection between the driver and the transmission unit is released. This provides advantages of not only preventing damage to the driver while a user manually closes the door but also allowing the door to be closed smoothly.

According to an embodiment, there is an advantage in that damage to the driver for automatic opening is prevented when the door is manually opened, and operating noise is reduced.

### BRIEF DESCRIPTION OF THE DRAWINGS

FIG. 1 is a perspective view showing a portion of a refrigerator according to a first embodiment.

FIG. 2 is a plan view of a refrigerator according to a first embodiment.

FIG. 3 is an enlarged view showing a door opening and closing device installed at a refrigerator according to a first embodiment.

FIG. 4 is a drawing showing a portion of a power transmission portion of a door opening and closing device according to a first embodiment.

FIG. 5 is a cross-sectional view of a fifth gear for transmitting power to a first operating portion.

FIG. 6A is a perspective view of a transmission gear, and FIG. 6B is a side view of a transmission gear.

FIG. 7 is a perspective view showing a clutch device of a first embodiment.

FIG. 8 is a front view showing a clutch device according to a first embodiment.

FIG. 9 is an exploded perspective view of a clutch device according to a first embodiment.

FIG. 10 is a cross-sectional view taken along line 10-10 of FIG. 7.

FIG. 11 is a view showing inclined surfaces of a second input gear and a first output gear according to a first embodiment.

FIG. 12 is a view showing a state in which a second input gear is moved in a third direction for automatic opening of the door, and FIGS. 13 to 20 are views showing a process in which the door is automatically opened.

FIG. 21 is a view illustrating a state in which a second input gear is moved in a fourth direction for automatic closing of a door.

FIGS. 22 to 25 are drawings showing a process of automatically opening a door.

FIGS. 26A to 26D are views showing a process in which a moving portion of a fifth gear moves into a slot of a transmission gear while a door is automatically closed.

FIG. 27 is a control block diagram of a refrigerator according to a first embodiment.

FIGS. 28 and 29 are drawings showing a process of manually opening a door.

FIG. 30 is a view illustrating a second input gear and an output gear according to a second embodiment.

FIG. 31 is a side view of a second input gear according to a third embodiment.

FIG. 32 is an exploded perspective view of a second input gear according to a third embodiment.

FIG. 33 is a plan view of a second input gear according to a third embodiment.

FIG. 34 is a plan view of a second gear portion according to a third embodiment.

FIG. 35 is a bottom view of a second input gear according to a third embodiment.

FIG. 36 is a cross-sectional view taken along line 36-36 of FIG. 33, illustrating a state in which a first gear portion and an output gear are normally coupled.

FIG. 37 is a view illustrating a relative movement between a first gear portion and a second gear portion in a state where a first gear portion is interfered with an output gear.

### DETAILED DESCRIPTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected, coupled or joined to the latter or may be “connected”, coupled” or “joined” to the latter with a third component interposed therebetween.

In this specification, at least one of component A and component B may be interpreted as including component A, component B, or components A+B.

Furthermore, at least one of component A or component B may be interpreted as including component A, component B, or components A+B.

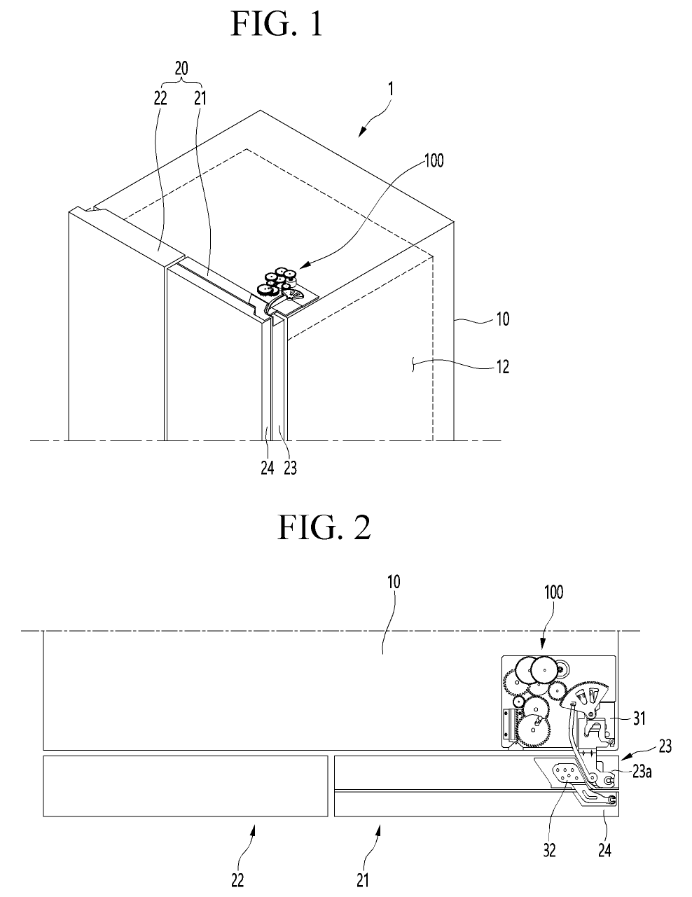

FIG. 1 is a perspective view showing a portion of a refrigerator according to a first embodiment. FIG. 2 is a plan view of a refrigerator according to a first embodiment.

Referring to FIGS. 1 and 2, a refrigerator 1 according to the present embodiment may include a cabinet 10 to form a storage space 12 and a door 20 that opens and closes the storage space 12.

The storage space 12 may include, for example, a refrigerating chamber. Alternatively, the storage space 12 may include, for example, a freezing chamber. Alternatively, although not shown, the storage space 12 may further include an additional storage space.

The door 20 may be a refrigerating chamber door or a freezing chamber door. The door 20 may include a first door 21 that opens and closes a portion of the storage space 12. The door 20 may further include a second door 22 that opens and closes another portion of the storage space 12. Alternatively, a single door 20 may open and close a single storage space 12, or may open and close multiple storage spaces 12 simultaneously.

The door 20 may be configured as a single door, or may include a main door 23 and a sub-door 24.

As an example, FIG. 2 illustrates that the first door 21 among the doors 20 is composed of a main door 23 (or inner door) and a sub-door 24 (or outer door), but is not limited thereto, and it is also possible for the first door 21 to be composed of a single door.

The main door 23 may open and close the storage space 12, and the sub-door 24 may be rotatable with respect to the main door 23. The sub-door 24 may be rotatably connected to the main door 23 or rotatably connected to the cabinet 10.

A refrigerator of the present embodiment may further include a door opening and closing device 100 for opening the door 20. When the door 20 includes a plurality of doors 21 and 22, the door opening and closing device 100 may open some or all of the plurality of doors 21 and 22.

FIG. 2 illustrates, as an example, the door opening and closing device 100 opening the first door 21 among the doors 20.

In the present embodiment, the door 20 may be automatically opened by the door opening and closing device 100. Additionally, the door 20 may be manually opened by a user.

The door opening and closing device 100 may be installed at an upper surface of the cabinet 10, for example, but may also be installed at a lower surface. A portion of the door opening and closing device 100 may be connected to an upper (or lower) side of the door 20.

When the door 20 includes a main door 23 and a sub door 24, a portion of the door opening and closing device 100 may be connected to an upper side of the main door 23. That is, when the door opening and closing device 100 is operated, the main door 23 may be automatically opened.

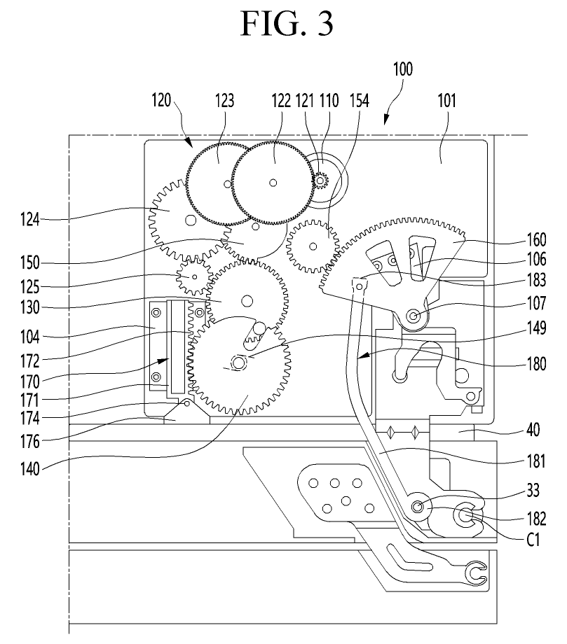

A gasket 40 of FIG. 3 may be provided between the door 20 and the cabinet 10 to limit leakage of cold air from the storage space 12. For example, a gasket 40 is coupled to the door 20. A magnet may be provided inside the gasket 40. The gasket 40 may be maintained in contact with the cabinet 10 by the magnet.

Hereinafter, the door opening and closing device 100 of the present embodiment will be described in detail.

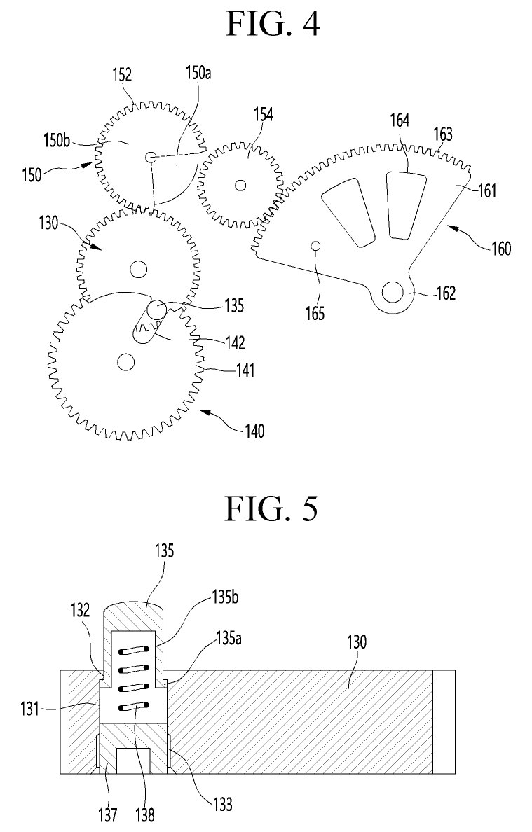

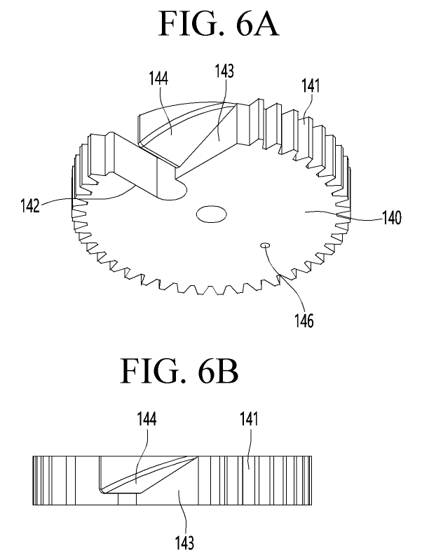

FIG. 3 is an enlarged view showing a door opening and closing device installed at a refrigerator according to a first embodiment. FIG. 4 is a drawing showing a portion of a power transmission portion of a door opening and closing device according to a first embodiment. FIG. 5 is a cross-sectional view of a fifth gear for transmitting power to a first operating portion. FIG. 6A is a perspective view of a transmission gear, and FIG. 6B is a side view of a transmission gear.

Referring to FIGS. 2 to 6B, the main door 23 may be rotatably connected to the cabinet 10 by a first hinge bracket 31. An upper surface of the main door 23 may include a recess 23a that is recessed downward. The first hinge bracket 31 may be connected to the recess 23a.

The sub-door 24 may be rotatably connected to the main door 23 by a second hinge bracket 32.

A door opening and closing device 100 of the present embodiment may include a driver 110. The driver 110 may include, for example, a motor capable of rotating in both directions. When the motor rotates in a forward direction, the door 20 may be automatically opened. After the door is automatically opened, when the motor rotates in a reverse direction, the door 20 may be automatically closed.

The door opening and closing device 100 may further include a power transmission portion 120 for transmitting power of the driver 110.

The door opening and closing device 100 may further include a first operating portion 170 (or first door opening portion) that operates by receiving power from the power transmission portion 120. The door opening and closing device 100 may further include a second operating portion 180 (or second door opening portion) that operates by receiving power from the power transmission portion 120.

In the auto opening process of the door 20, the first operating portion 170 and the second operating portion 180 may operate sequentially. The second operating portion 180 functions as a door closing portion to close the door during an auto closing process of the door.

The door opening and closing device 100 may further include a first transmission unit that transmits power to the first operating portion 170. The door opening and closing device 100 may further include a second transmission unit that transmits power to the second operating portion 180.

The power transmission portion 120 may include a plurality of gears. The door opening and closing device 100 may include a frame 101. The plurality of gears may be rotatably supported by the frame 101. The frame 101 may cover at least a portion of components constituting the door opening and closing device 100.

For example, the plurality of gears may include a motor gear 121 connected to a shaft of the driver 110.

The plurality of gears may further include first to fifth gears 122, 123, 124, 125, and 130 that are connected to each other. However, it should be noted that there is no limitation on a number of the plurality of gears in the present embodiment. In addition, it should be noted that there is no limitation on a shape of the plurality of gears.

The first gear 122 and the second gear 123 may be reduction gears. The third to fifth gears 124, 125, and 130 may be idle gears.

At least one of the third to fifth gears may be a two-stage gear having portions with different diameters.

The last gear among the plurality of gears may be connected to the first transmission unit. For example, the fifth gear 130 may be connected to the first transmission unit.

The first transmission unit may transmit power to the first operating portion 170 during a portion of the auto opening process of the door 20. For example, the first transmission unit may transmit power to the first operating portion 170 in an initial period of the auto opening process. The first transmission unit can block power transmission to the first operating portion 170 in another period of the auto opening process. That is, the first transmission unit can block power transmission during operation of the first operating portion 170.

The first transmission unit may include a transmission gear 140. The transmission gear 140 may be connected to the fifth gear 130.

The fifth gear 130 may include a moving portion 135. The moving portion 135 may be provided to be movable at a position spaced apart from a rotational center of the fifth gear 130. The moving portion 135 may move in a direction parallel to a rotational center line of the fifth gear 130.

The fifth gear 130 may include a first portion 131 in which the moving portion 135 is received. The fifth gear 130 may include a second portion 132 as an opening through which the moving portion 135 passes. A diameter of the first portion 131 may be greater than a diameter of the second portion 132.

The fifth gear 130 may further include a third portion 133 as an opening for insertion of the moving portion 135. The first portion 131 may be positioned between the second portion 132 and the third portion 133. A diameter of the third portion 133 may be equal to or greater than a diameter of the first portion 131.

The fifth gear 130 may further include a cover portion 137 for covering the third portion 133. A diameter of the cover portion 137 may be equal to or less than that of the third portion 133. A portion of the cover portion 137 may be inserted into the first portion 131. The cover portion 137 may restrict the moving portion 135 from being separated from the fifth gear 130 toward the third portion 133.

A portion protruding outwardly from the fifth gear 130 in the moving portion 135 may include a round surface. The round surface may be in contact with the transmission gear 140.

The moving portion 135 may be formed in a cylindrical shape, for example. Based on the drawing, an upper surface of the moving portion 135 may include a round surface.

The moving portion 135 may further include an extension 135a extending outward. A portion of the moving portion 135 may pass through the second portion 132 and protrude outwardly of the fifth gear 130. The extension 135a may be caught by a step formed by a difference in diameter between the first portion 131 and the second portion 132. The extension 135a can be moved within the first portion 131.

An upward movement of the moving portion 135 can be limited by the extension 135a. A downward movement of the extension 135a can be limited by the cover portion 137 or an elastic member 138 described below.

The fifth gear 130 may further include an elastic member 138 that provides elastic force to the moving portion 135. The elastic member 138 may elastically support the moving portion 135. The elastic member 138 may be, for example, a coil spring.

A groove 135b may be formed in the moving portion 135 to receive a portion of the elastic member 138. Another side of the elastic member 138 may be supported by the cover portion 137.

After the moving portion 135 is moved downward by an external force, when the external force is removed, the moving portion 135 may be moved upward by the elastic force of the elastic member 138.

The transmission gear 140 may be provided with a gear tooth 141 on a portion of the circumferential surface. Another portion of the transmission gear 140, where the gear tooth 141 is not provided, may be provided with a slot 142 in which the moving portion 135 is received. The slot 142 may pass through the transmission gear 140 in a direction parallel to a rotational center line of the transmission gear 140. Alternatively, the slot 142 may be recessed toward a rotational center of the transmission gear 140 on the circumferential surface.

The moving portion 135 may be selectively received in the slot 142. When the moving portion 135 is received in the slot 142, the rotational power of the fifth gear 130 may be transmitted to the transmission gear 140. On the other hand, when the moving portion 135 is removed from the slot 142, a rotational power of the fifth gear 130 is not transmitted to the transmission gear 140.

In this embodiment, a state in which the moving portion 135 is received in the slot 142 may be referred to as a connected state of the fifth gear 130 and the transmission gear 140. In the connected state of the fifth gear 130 and the transmission gear 140, the transmission gear 140 may rotate together when the fifth gear 130 rotates.

A state in which the moving portion 135 is removed from the slot 142 may be referred to as a disconnected state of the fifth gear 130 and the transmission gear 140. In the disconnected state of the fifth gear 130 and the transmission gear 140, even if the fifth gear 130 rotates, the transmission gear 140 may not rotate.

The transmission gear 140 may further include a recess 143 provided at one side of the slot 142. The recess 143 may be in communication with the slot 142.

The recess 143 may provide a path or space through which the moving portion 135, located at an outside of the slot 142, may be inserted into the slot 142. One surface forming the recess 143 in the transmission gear 140 may include an inclined surface 144. The inclined surface 144 may be inclined such that a recessed depth of the recessed portion 143 upward from a bottom surface decreases toward the slot 142. The moving portion 135 may be in contact with the inclined surface 144.

The transmission gear 140 may be connected to an elastic body 149. In order to open the door 20, the transmission gear 140 may be rotated in the other direction. While the transmission gear 140 rotates in the other direction, when the moving unit 135 is removed from the slot 142, the elastic body 149 may provide an elastic force so that the transmission gear 140 returns to an initial position in one direction.

The elastic body 149 may be, for example, a torsion spring, but it should be noted that there is no limitation on the type of spring. The transmission gear 140 may be provided with a coupling portion 146 to which the elastic body 149 is coupled.

As another example, it is also possible for the elastic body 149 to provide elastic force to the first operating portion 170. In this case, when the moving portion 135 is removed from the slot 142, the elastic body 149 can provide elastic force so that the first operating portion 170 returns to an initial position. In the process of returning the first operating portion 170 to the initial position, the transmission gear 140 can return to the initial position in one direction.

In the present embodiment, the first transmission unit acts as a clutch that transmits power to or blocks power transmission to the first operating portion 170 in the auto opening process of the door 20, and thus may be called a first clutch unit.

The first operating portion 170 may be engaged with the transmission gear 140. The first operating portion 170 may be composed of a single member or a plurality of members.

For example, the first operating portion 170 may include a first member 171 that engages with the transmission gear 140, and a second member 176 that is rotatably connected to the first member 171.

The first member 171 may include a rack gear 172. When the transmission gear 140 rotates, the first member 171 may move linearly. The door opening and closing device 100 may further include a guide portion 104 that guides the movement of the first member 171. The guide portion 104 may be formed integrally with the frame 101 or may be coupled to the frame 101.

The second member 176 may be rotatably connected to the first member 171 by a shaft 174. The second member 176 may be in contact with the door 20 during an auto opening process of the door. A portion of the second portion 176 may include a portion whose width or thickness increases as a distance from the shaft 174 increases.

The second transmission unit may include a first transmission portion 150. The first transmission portion 150 may be connected to the fifth gear 130.

The first transmission portion 150 may include a first portion 150a and a second portion 150b, which are distinguished by the presence or absence of gear teeth on the circumferential surface.

There are no gear teeth on the circumferential surface of the first portion 150a. There are gear teeth 152 on the circumferential surface of the second portion 150b. That is, the first transmission portion 150 may be a partial gear. The second portion 150b may be engaged with the fifth gear 130.

The second transmission unit may further include a second transmission portion 154. The second transmission portion 154 may be connected to the first transmission portion 150 during an auto opening process of the door 20. On the other hand, the second transmission portion 154 may be spaced apart from the first transmission portion 150 during a manual opening process of the door 20.

When the door 20 is closed, the first portion 150a may be positioned to face the second transmission portion 154 or to correspond to the second transmission portion 154.

When the driver 110 operates, the first transmission portion 150 may be rotated. When a predetermined time has elapsed since the driver 110 started operating or the first transmission portion 150 is rotated by a predetermined angle, the second portion 150b is connected to the second transmission portion 154 so that the second transmission portion 154 can be rotated.

A state in which the second portion 150b is connected to the second transmission portion 154 can be referred to as a connected state of the first transmission portion 150 and the second transmission portion 154. A state in which the second portion 150b is not connected to the second transmission portion 154 can be referred to as a disconnected state of the first transmission portion 150 and the second transmission portion 154. A position of the first transmission portion 150 in the disconnected state may be referred to as a disconnected position. In the auto opening process of the door 20, the first transmission portion 150 may move to a connected position so that the first transmission portion 150 and the second transmission portion 154 may be connected.

The second transmission unit may further include a third transmission portion 160. The third transmission portion 160 may be connected to the second transmission portion 154. The third transmission portion 160 may be connected to the second operating portion 180. The third transmission portion 160 may transmit the rotational force of the second transmission portion 154 to the second operating portion 180.

The third transmission portion 160 may include, for example, a body 161 formed in a fan shape. A gear tooth 163 may be formed on one surface of the body 161.

Another surface of the body 161 may be provided with a connection portion 162 to which a shaft 107 providing a center of rotation is connected. The shaft 107 may be provided at the first hinge bracket 31, or may be provided on a separate member 106 from the first hinge bracket 31. At least a portion of the third transmission portion 160 may overlap the first hinge bracket 31 in a vertical direction.

The third transmission portion 160 may further include a connection portion 165 to which the second operating portion 180 is connected. The second operating portion 180 may be rotatably connected to the third transmission portion 160 at a position spaced apart from a rotational center of the third transmission portion 160.

The third transmission portion 160 may include one or more holes. The one or more holes may improve a strength of the third transmission portion 160. A weight of the third transmission portion 160 may be reduced by the one or more holes.

In a case where a plurality of holes are formed in the third transmission portion 160, the plurality of holes can also be used to detect a position of the third transmission portion 160 by a position detection sensor.

The second operating portion 180 may include a body 181 (or link). The body 181 may extend from the cabinet 10 toward the door 20.

The second operating portion 180 may include a first coupling portion 182 provided on one side of the body 181. The first coupling portion 182 may be rotatably connected to a shaft 33 provided on the door 20 (for example, the main door). Alternatively, it is also possible for the first coupling portion 182 to have a shaft. The first coupling portion 182 may be positioned in the recess 23a of the main door 22. The shaft 33 may be provided at the first hinge bracket 31, or may be provided at a separate member spaced apart from or coupled to the first hinge bracket 31.

The body 181 may be formed in a straight shape or in a shape that is bent one or more times. When the door 20 is closed, the first coupling portion 182 may be positioned near a rotation center C1 of the door 20 (or a rotation center of the main door). For example, when the door 20 is closed, the first coupling portion 182 may be positioned closer to the cabinet 10 or the gasket 40 than the rotation center C1 of the door 20.

The second operating portion 180 may include a second coupling portion 183 provided on the other side of the body 181. The second coupling portion 183 may be connected to the third transmission portion 160.

By a shape of the first transmission portion 150, the second transmission unit can transmit the power of the driver 110 to the second operating portion 180 during the automatic opening and closing process of the door 20, and acts as a clutch to block the movement power of the second operating portion 180 from being transmitted to the driver 110 during the manual opening and closing process of the door 20. Therefore, the second transmission unit can be called a second clutch unit.

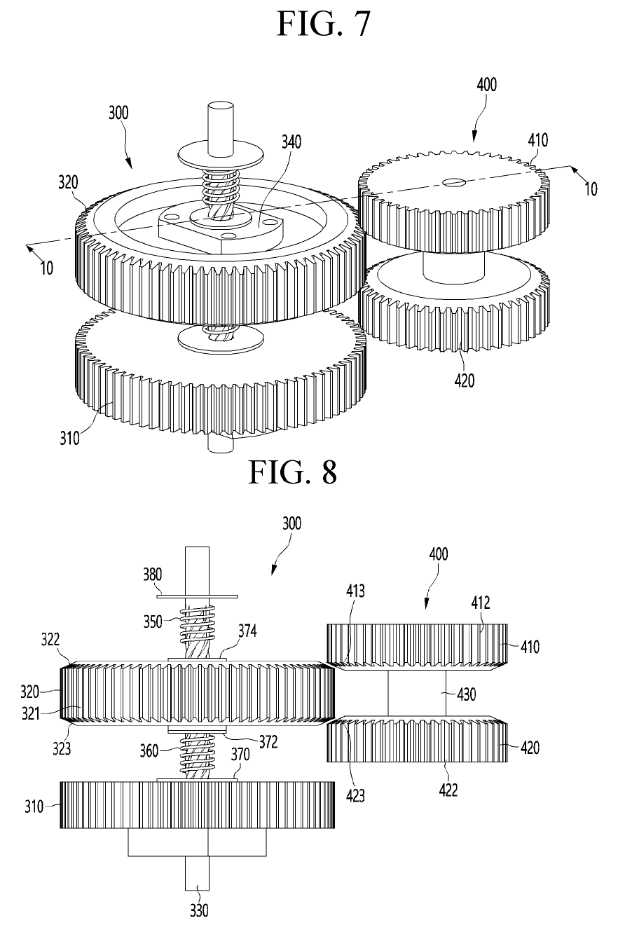

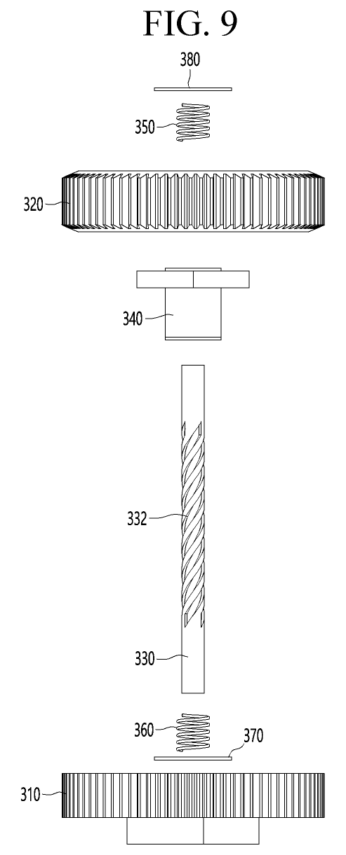

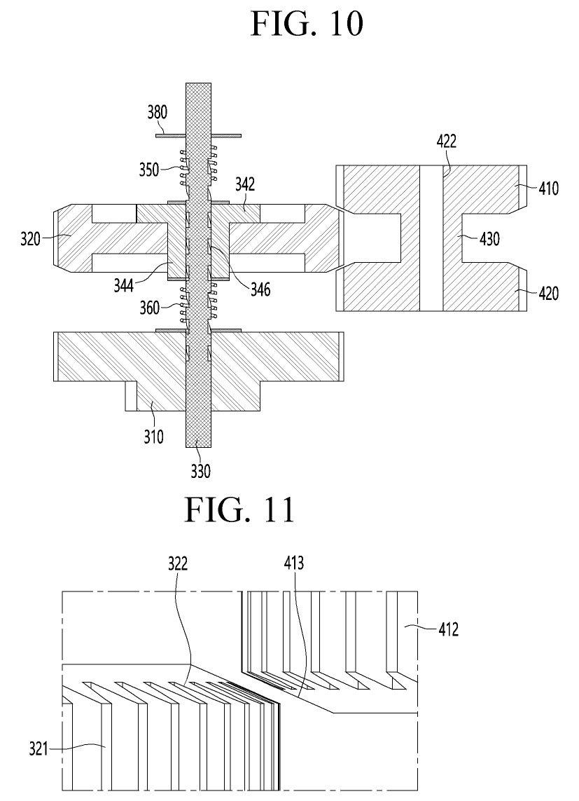

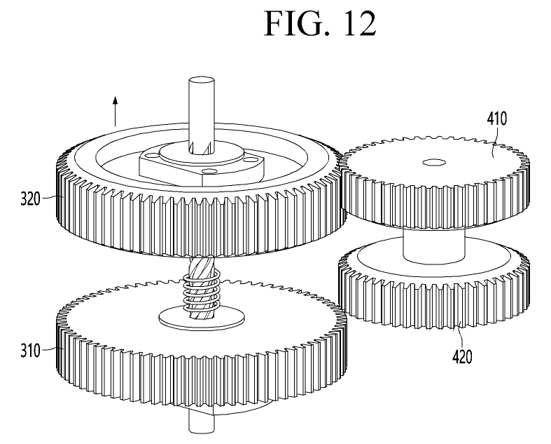

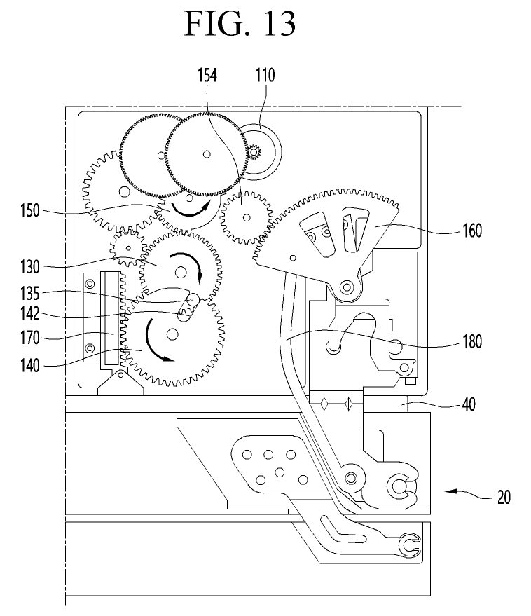

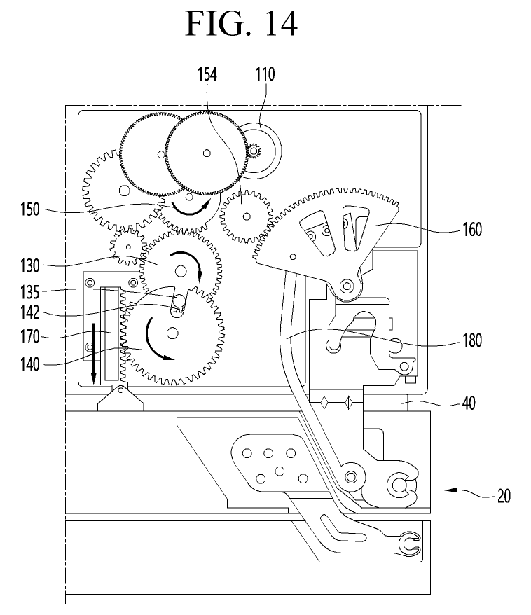

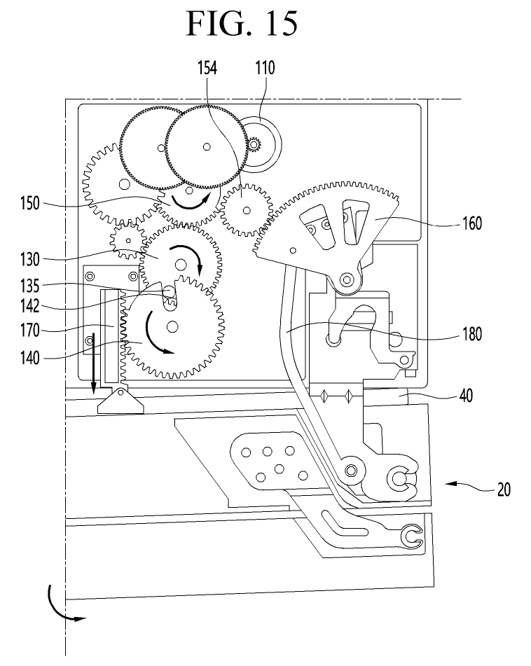

FIG. 7 is a perspective view showing a clutch device of a first embodiment. FIG. 8 is a front view showing a clutch device according to a first embodiment. FIG. 9 is an exploded perspective view of a clutch device according to a first embodiment. FIG. 10 is a cross-sectional view taken along line 10-10 of FIG. 7. FIG. 11 is a view showing inclined surfaces of a second input gear and a first output gear according to a first embodiment.

Referring to FIGS. 7 to 11, one of a plurality of gears constituting the power transmission portion 120 may include a clutch device (or clutch gear assembly).

The clutch device may block power transmission between the driver 110 and the second transmission unit when the driver 110 is stopped.

For example, after an automatic opening of the door 20 is completed, the driver 110 may stop before an automatic closing operation of the door 20 begins. Alternatively, the driver 110 may stop unintentionally during the auto opening process of the door 20.

When the automatic opening of the door 20 is completed, the first transmission portion 150 and the second transmission portion 154 are connected. If a clutch device is not present, the first transmission unit 150 is connected to the driver 110 by the power transmission unit 120. Accordingly, when a user manually closes the door, a closing force of the door 20 may be transmitted to the driver 110. In this case, there is a possibility that the driver 110 may be damaged, or the door 20 may not be closed smoothly or softly due to a resistance force of gears. In addition, in a case where the driver 110 unintentionally stops during operation, even when the first transmission unit 150 and the second transmission unit 154 are in a connected state, a closing force of the door 20 may be transmitted to the driver 110 when a user manually closes the door.

On the other hand, in a case where the power transmission portion 120 includes a clutch device, the connection between the driver 110 and the first transmission portion 150 is released if the driver 110 stops after operating or during operation. Accordingly, even when a user manually closes the door, a closing force of the door 20 is not transmitted to the driver 110, and the door 20 can be closed manually and smoothly.

Hereinafter, the clutch device will be described in detail.

At least two adjacent gears among a plurality of gears constituting the power transmission portion 120 may constitute a clutch device.

The clutch device may include an input gear assembly 300 (or an input unit) and an output gear assembly 400 (or an output unit).

Any one of the first to fourth gears 121 to 124 may be the input gear assembly 300.

Any one of the second to fifth gears 123, 124, 125, and 130 adjacent to the input gear assembly 300 may be the output gear assembly 400.

The input gear assembly 300 and the output gear assembly 400 may be connected when the driver 110 is operated. On the other hand, the connection between the input gear assembly 300 and the output gear assembly 400 may be released when the driver 110 is stopped.

The input gear assembly 300 may include a first input gear 310. The first input gear 310 may be rotated when the driver 110 is operated. The first input gear 310 may maintain a state of being connected to the driver 110.

The input gear assembly 300 may include a shaft 330 that is rotated together with the first input gear 310. The shaft 330 may be coupled to pass through the first input gear 310.

The input gear assembly 300 may further include a second input gear 320 (or a clutch gear) spaced apart from the first input gear 310 (or an input gear) in an axial direction of the shaft 330.

The second input gear 320 may be moved in the axial direction of the shaft 330 when the first input gear 310 is rotated.

The second input gear 320 may be directly coupled to the shaft 330. A screw 332 or a screw-shaped groove or protrusion may be formed on the shaft 330. A screw-shaped or screw-type protrusion or groove corresponding to a shape of the shaft 330 may also be formed on a surface of the second input gear 320 to which the shaft 330 is coupled. Accordingly, when the shaft 330 is rotated, the second input gear 320 may be moved in the axial direction of the shaft 330.

Alternatively, the second input gear 320 may be coupled to the shaft 330 by a connection member 340. A screw 332 or a screw-shaped groove or protrusion may be formed on the shaft 330. A screw 346 or a screw-shaped protrusion or groove corresponding to a shape of the shaft 330 may also be formed on a surface of the connection member 340 to which the shaft 330 is coupled. Accordingly, when the shaft 330 is rotated, the second input gear 320 coupled to the connection member 340 may be moved in the axial direction of the shaft 330.

The connection member 340 may include an insertion portion 344 inserted into the second input gear 320. For example, the insertion portion 344 may pass through the second input gear 320 and protrude downward from the second input gear 320.

The connection member 340 may further include an extension 342 extending in a horizontal direction from the insertion portion 344. In a state where the insertion portion 344 passes through the second input gear 320, the extension 342 may be seated on an upper side of the second input gear 320.

As another example, the shaft 330 may include a worm gear. The connection member 340 or the second input gear 320 may also include a gear capable of engaging with the worm gear so that the second input gear 320 is movable in the axial direction of the shaft 330.

When the driver 110 is operated in a forward direction, the second input gear 320 may move upward with respect to the drawings. On the other hand, when the driver 110 is operated in a reverse direction, the second input gear 320 may move downward with respect to the drawings. Of course, it is also possible that the moving direction of the second input gear 320 is reversed.

The input gear assembly 300 may further include a first elastic member 350 and a second elastic member 360.

The second elastic member 360 may be positioned between the second input gear 320 and the first input gear 310. The second input gear 320 may be positioned between the first elastic member 350 and the second elastic member 360.

For example, with reference to FIG. 10, the first elastic member 350 may be positioned at an upper side of the second input gear 320. The second elastic member 360 may be positioned at a lower side of the second input gear 320.

The first elastic member 350 may be, for example, a coil spring. The first elastic member 350 may be disposed to surround the shaft 330.

One end of the first elastic member 350 may be seated on an upper surface of the connection member 340 or may be seated on a washer 374 in contact with the upper surface of the connection member 340.

Another end of the first elastic member 350 may be in contact with a stopper 380 coupled to the shaft 330. The stopper 380 may restrict an upward movement of the first elastic member 350.

The first elastic member 350 may restrict an upward movement of the second input gear 320 in a process in which the second input gear 320, which is moved downward, returns to an initial position due to rotational inertia when the driver 110 is stopped.

The second elastic member 360 may be, for example, a coil spring. The second elastic member 360 may be disposed to surround the shaft 330. One end of the second elastic member 360 may be supported by a washer 370 coupled to the shaft 330. For example, the washer 370 may be seated on an upper side of the first input gear 310. Of course, it is also possible that the washer 370 is omitted.

Another end of the second elastic member 360 may support a lower surface of the connection member 340. Alternatively, it is also possible that the other end of the second elastic member 360 supports a washer 372 in contact with the lower surface of the connection member 340.

The second elastic member 360 may restrict a downward movement of the second input gear 320 in a process in which the second input gear 320, which is moved upward, returns to an initial position due to rotational inertia when the driver 110 is stopped.

In the present specification, any one of an upward direction and a downward direction of the second input gear 320 may be referred to as a third direction, and the other may be referred to as a fourth direction.

The output gear assembly 400 may include a first output gear 410 and a second output gear 420. The first output gear 410 and the second output gear 420 may have the same rotation center. The output gear assembly 400 may include a coupling hole to which a shaft (not shown) is coupled. A shaft or the rotation center of the first and second output gears 410 and 420 (or the output gear assembly) may be spaced apart from a shaft or the rotation center of the first input gear 310 (or the input gear assembly) in a horizontal direction.

The first output gear 410 and the second output gear 420 may be, for example, spaced apart from each other in a vertical direction and may be connected by a connection portion 430. Accordingly, the first output gear 410 and the second output gear 420 may be rotated together.

As shown in FIG. 8, when the driver 110 is stopped, the second input gear 320 may be maintained in a state of being positioned at an initial position by the first elastic member 350 and the second elastic member 360.

At the initial position of the second input gear 320, a connection between the first output gear 410 and the second input gear 320 may be released, and a connection between the second output gear 420 and the second input gear 320 may be released.

For example, the first output gear 410 may be connected to the second input gear 320 that is moved upward when the driver 110 is operated in a forward direction. When the first output gear 410 is connected to the second input gear 320, power from the driver 110 may be transmitted to the first output gear 410 through the second input gear 320.

For example, the second output gear 420 may be connected to the second input gear 320 that is moved downward when the driver 110 is operated in a reverse direction. When the second output gear 420 is connected to the second input gear 320, power from the driver 110 may be transmitted to the second output gear 420 through the second input gear 320.

The second input gear 320 may include a plurality of gear teeth 321. A first inclined surface 322 may be formed at a portion (for example, an upper portion) of each of the gear teeth 321 facing the first output gear 410 so that the second input gear 320 is smoothly connected to the first output gear 410.

The first output gear 410 may also include a plurality of gear teeth 412, and an inclined surface 413 may be formed at a portion (for example, a lower portion) of each of the gear teeth 412 facing the gear teeth 321 of the second input gear 320.

When the first inclined surface 322 and the inclined surface 413 of the first output gear 410 are in contact with each other while the second input gear 320 is moving upward, the second input gear 320 may naturally rotate relative to the first output gear 410, so that the gear teeth 321 of the second input gear 320 can be engaged with the gear teeth 412 of the first output gear 410.

In a state where the second input gear 320 and the first output gear 410 are connected, an upward movement of the second input gear 320 may be restricted, and thus the first output gear 410 may be rotated when the second input gear 320 is rotated.

A second inclined surface 323 may be formed at a portion (for example, a lower portion) of each of the gear teeth 321 facing the second output gear 420 so that the second input gear 320 is smoothly connected to the second output gear 420.

The second output gear 420 may include a plurality of gear teeth 422, and an inclined surface 423 may be formed at a portion (for example, an upper portion) of each of the gear teeth 422 facing the gear teeth 321 of the second input gear 320.

When the second inclined surface 323 and the inclined surface 423 of the second output gear 420 are in into contact with each other while the second input gear 320 is moving downward, the second input gear 320 may naturally rotate relative to the second output gear 420, so that the gear teeth 321 of the second input gear 320 can be engaged with the gear teeth 422 of the second output gear 420.

In a state where the second input gear 320 and the second output gear 420 are connected, a downward movement of the second input gear 320 may be restricted, and thus the second output gear 420 may be rotated when the second input gear 320 is rotated.

Hereinafter, a process of opening and closing the door will be described.

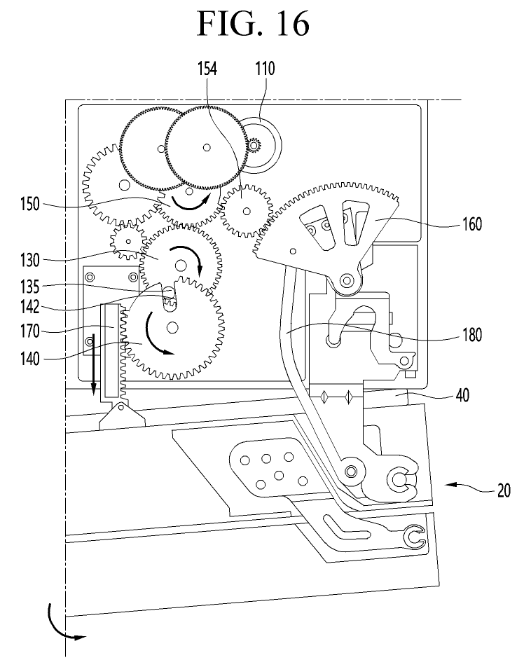

FIG. 12 is a view showing a state in which a second input gear is moved in a third direction for automatic opening of the door, and FIGS. 13 to 20 are views showing a process in which the door is automatically opened.

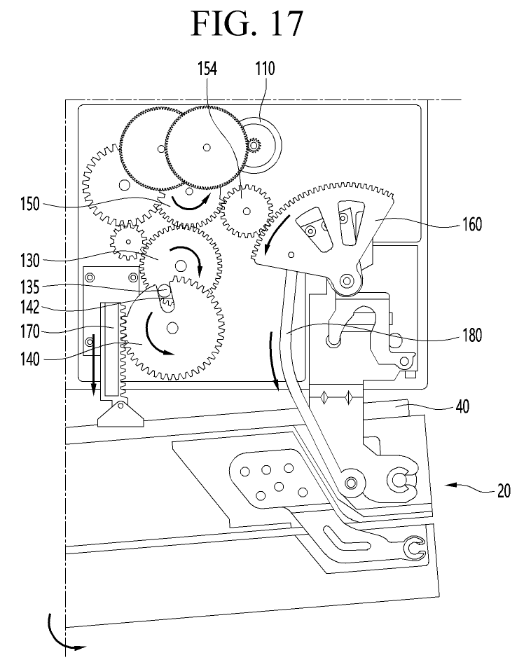

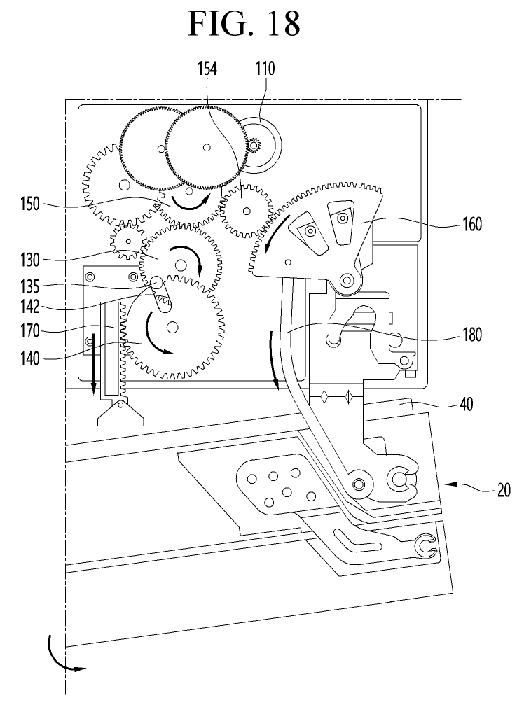

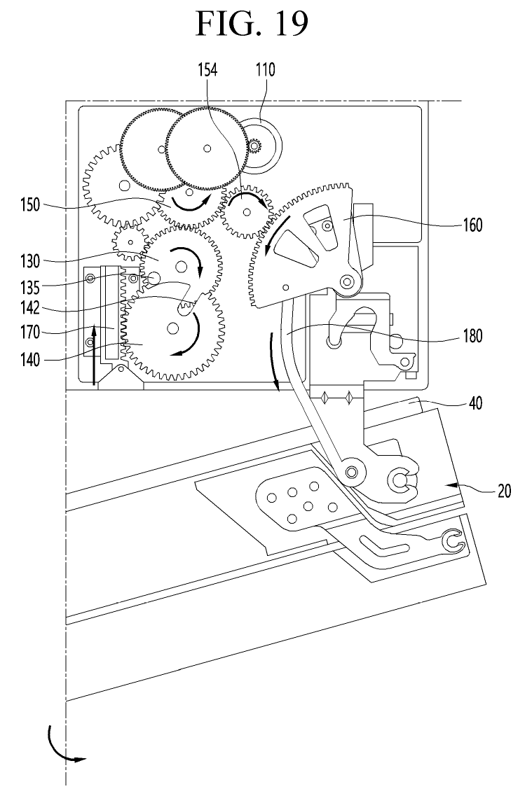

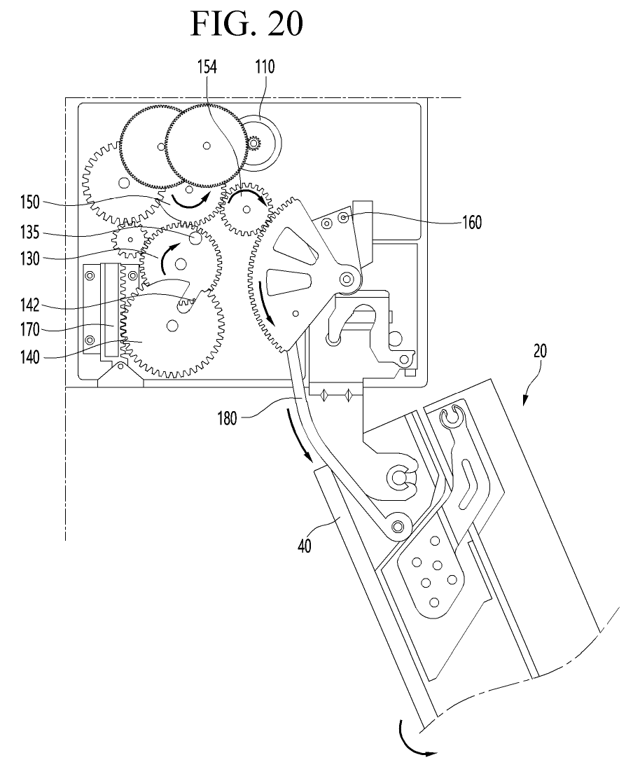

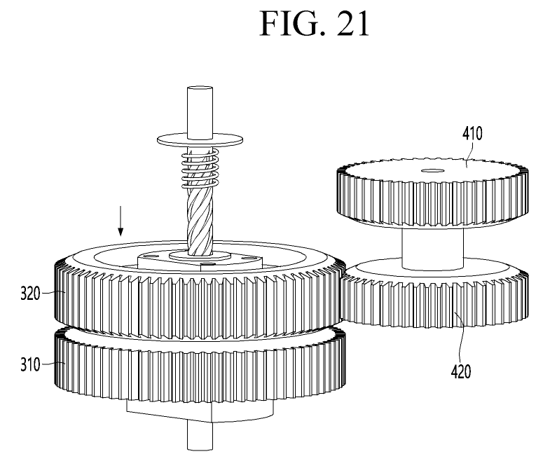

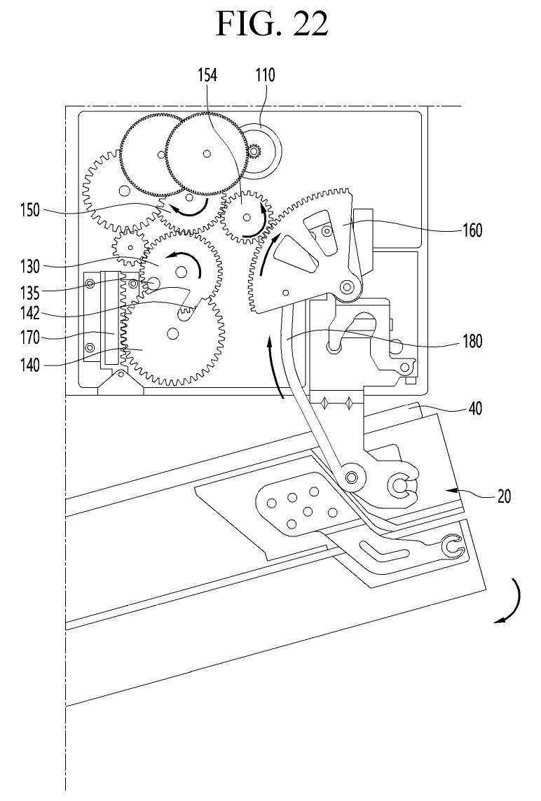

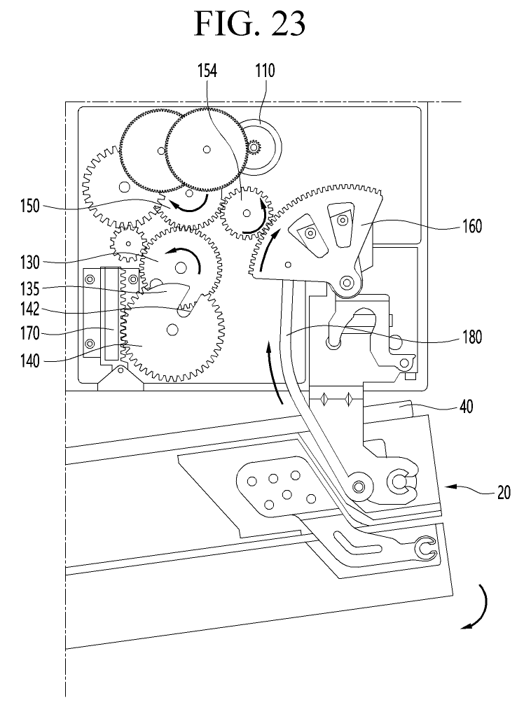

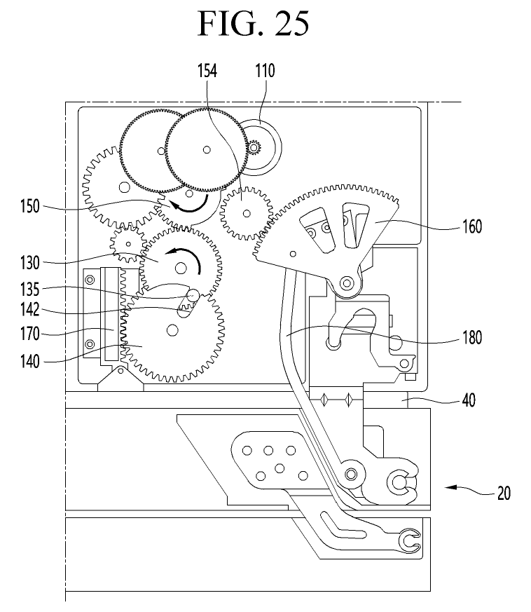

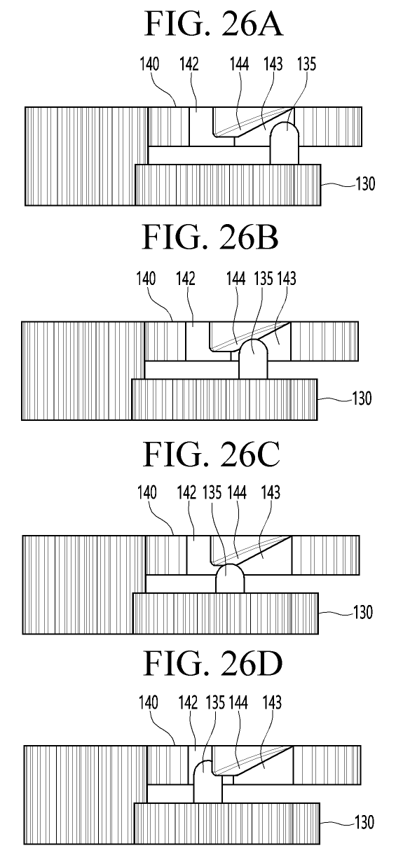

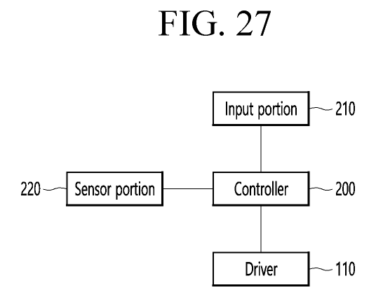

FIG. 21 is a view illustrating a state in which a second input gear is moved in a fourth direction for automatic closing of a door. FIGS. 22 to 25 are drawings showing a process of automatically opening a door. FIGS. 26A to 26D are views showing a process in which a moving portion of a fifth gear moves into a slot of a transmission gear while a door is automatically closed. FIG. 27 is a control block diagram of a refrigerator according to a first embodiment.

Referring to FIGS. 3 to 27, a refrigerator of the present embodiment may further include a controller 200. The controller 200 may be installed at or spaced apart from an object for control. The controller 200 may be located inside or outside the object for control.

For example, the controller 200 may be provided at the cabinet 10 or the door 20.

The controller 200 may control the driver 110. The controller 200 may be located outside the driver 110. The controller 200 may control the driver 110 alone, or may also control other components in the refrigerator besides the driver 110.

The refrigerator 1 may further include an input portion 210. The input portion 210 may input a door opening command for opening the door 20.

The input portion 210 may include a touch sensor for detecting a user's touch on a front surface of the door 20, or may include a knock sensor for detecting a plurality of knocks applied to a front surface of the door 20. Alternatively, the input portion 210 may include a capacitive sensor, a vibration detection sensor, or a sound wave detection sensor. Alternatively, the input portion 210 may include a mechanical button or a touch screen through which a user's command may be input. Since the input portion 210 can receive a user's command input or detect a user's command, the input portion 210 may also be referred to as an input detection portion.

The input portion 210 may be provided at the cabinet 10 or the door 20.

The refrigerator 1 may further include a sensor portion 220. The sensor portion 220 may detect opening and closing of the door 20. The sensor portion 220 may be provided at the cabinet 10 or the door 20.

An operation of the driver 110 for automatic opening of the door 20 may be performed in a state in which the door 20 is closed. That is, the driver 110 may operate when an automatic opening command for the door 20 is input while a closed state of the door 20 is detected by the sensor portion 220.

In a state in which the door 20 is closed, the first operating portion 170 and the second operating portion 180 may be located at an initial position. In a state in which the driver 110 is stopped, the connection gear 320 may be located at the initial position.

In the initial position of the first operating portion 170, the first operating portion 170 may be spaced apart from a rear surface of the door 20. The transmission gear 140 may be located between the first operating portion 170 and the second operating portion 180. The second operating portion 180 may be located closer to the rotation center C1 of the door 20 than the first operating portion 170.

In the initial position of the second operating portion 180, the second coupling portion 183 may be located farther from the front surface of the cabinet 10 than the first operating portion 170. The driver 110 may be located farther from the front surface of the cabinet 10 than the second coupling portion 183.

### Process of Automatically Opening and Closing the Door

In the state in which the door 20 is closed, a door opening command may be input through the input portion 210. Then, the controller 200 may control the driver 110 for automatic opening of the door 20.

Referring to FIG. 13, the controller 200 may cause the driver 110 to operate in a forward direction. For example, the controller 200 may rotate the motor in the forward direction. When the motor is rotated in the forward direction, power of the motor may be transmitted to the first operating portion 170 through the power transmission portion 120 and the first transmission unit.

When the driver 110 is stopped, the second input gear 320 is positioned at an initial position, and when the driver 110 is operated in a forward direction, as shown in FIG. 12, the second input gear 320 does not rotate due to stationary inertia, so that the second input gear 320 moves in a third direction to be connected to the first output gear 410. Accordingly, when the driver 110 is operated in the forward direction, power from the driver 110 may be transmitted to a first operating portion 170 by the first output gear 410. The second input gear 320 may transmit power to the first output gear 410 in a horizontal direction. Therefore, a rotational direction of the second input gear 320 and a rotational direction of the first output gear 410 (or the output gear assembly) may be opposite to each other. Alternatively, the input gear assembly may transmit power to the output gear assembly in a direction intersecting the axial direction of the shaft 330.

In the initial position of the first transmission portion 150, the first transmission portion 150 and the second transmission portion 154 are in a disconnected state. Therefore, even if the driver 110 operates in the forward direction and the first transmission portion 150 is rotated, the second transmission portion 154 maintains a stopped state. In the state in which the second transmission portion 154 is stopped, the third transmission portion 160 and the second operating portion 180 also maintain a stopped state.

For the operation of the first operating portion 170, the fifth gear 130 may be rotated in one direction (clockwise on the drawing), and the transmission gear 140 may be rotated in the other direction (counterclockwise on the drawing). When the transmission gear 140 is rotated in the other direction, the first operating portion 170 moves from an initial position toward an end position in a first direction (for example, a front-back direction) (a door opening direction).

As shown in FIG. 14, when the first operating portion 170 moves in the first direction, the first operating portion 170 may be in contact with the rear surface of the door 20. Even in a state in which the first operating portion 170 is in contact with the rear surface of the door 20, the second operating portion 180 maintains a stopped state.

As shown in FIG. 15, when the first operating portion 170 additionally moves in the first direction, the first operating portion 170 pushes the door 20 so that the door 20 is automatically rotated in an opening direction. Accordingly, at least a portion of the gasket 40 begins to be spaced apart from the cabinet 10.

As shown in FIG. 16, when the first operating portion 170 additionally moves in the first direction, the door 20 is further rotated in the opening direction so that the gasket 40 is completely separated from the cabinet 10.

In the present embodiment, the first operating portion 170 operates so that the gasket 40 is separated from the cabinet 10 at an initial stage of the automatic opening of the door 20.

The second operating portion 180 may remain inoperative until the gasket 40 is completely separated from the cabinet 10 by the operation of the first operating portion 170. Alternatively, the second operating portion 180 may operate after a portion of the gasket 40 is separated from the cabinet 10. In either case, the second operating portion 180 may operate after a set time has elapsed or after the first operating portion 170 has moved a set distance following the operation of the first operating portion 170.

Referring to FIG. 17, even after a portion of the gasket 40 is separated from the cabinet 10, the first operating portion 170 may additionally move in the first direction. In a state as shown in FIG. 17, the first transmission portion 150 may be engaged with the second transmission portion 154, so that the second transmission portion 154 may be rotated.

When the automatic opening of the door 20 starts and the first transmission portion 150 is rotated by an angle equal to or greater than a predetermined angle, the second portion 150b may be engaged with the second transmission portion 154, so that a rotational force of the first transmission portion 150 may be transmitted to the second transmission portion 154. When the second transmission portion 154 is rotated, the third transmission portion 160 is also rotated, so that the second operating portion 180 moves in a door opening direction. After the second operating portion 180 starts to operate, an opening angle of the door 20 may be increased.

The second operating portion 180 may move from an initial position to a door open position in the door opening direction. The second operating portion 180 may move from the door open position to the initial position in a door closing direction.

In a process in which the second operating portion 180 moves in the door opening direction, the door 20 is spaced apart from the first operating portion 170. In a state in which the first operating portion 170 and the door 20 are spaced apart from each other, the first operating portion 170 can no longer apply force to the door 20.

As shown in FIGS. 17 and 18, in some portions of the auto opening process of the door 20, the first operating portion 170 may operate together with the second operating portion 180. That is, the first operating portion 170 may move in the first direction toward the end position, and the second operating portion 180 may move to the door open position.

In the auto opening process of the door 20, the fifth gear 130 may be rotated only in one direction. As shown in FIG. 18, in a state in which the moving portion 135 of the fifth gear 130 is received in the slot 142 of the transmission gear 140, the transmission gear 140 is rotated in the other direction when the fifth gear 130 is rotated in the one direction.

While the transmission gear 140 is rotated in the other direction, the first operating portion 170 moves in the first direction.

Referring to FIG. 19, during the rotation of the fifth gear 130 in the one direction, the moving portion 135 may be removed from the slot 142 of the transmission gear 140. A point in time when the moving portion 135 is removed from the slot 142 of the transmission gear 140 may be the end position of the first operating portion 170.

When the moving portion 135 is removed from the slot 142 of the transmission gear 140, the rotational force of the fifth gear 130 is not transmitted to the transmission gear 140. That is, a connection between the fifth gear 130 and the transmission gear 140 may be released.

Accordingly, the transmission gear 140 is rotated in one direction by an elastic force of the elastic body 149 to return to the initial position.

In a process in which the transmission gear 140 is rotated in the one direction, the first operating portion 170 moves in a second direction from the end position to the initial position.

Referring to FIG. 20, when the second operating portion 180 continuously moves in the door opening direction and reaches the door open position, the opening angle of the door 20 becomes a maximum. In the present embodiment, the maximum opening angle of the door 20 may be greater than 90 degrees.

When the maximum opening angle of the door 20 is 90 degrees or more, there is an advantage in that a user can easily access the storage space 12 even without manually opening the door 20 further.

Meanwhile, after the automatic opening of the door 20 is completed, the driver 110 may be stopped before the automatic closing of the door 20.

When the driver 110 is stopped, the second input gear 320 continues to rotate due to rotational inertia, and thus may return to the initial position. That is, the connection between the second input gear 320 and the first output gear 410 may be released.

Alternatively, after the automatic opening of the door 20 is completed, the motor may be rotated in a reverse direction by a predetermined angle or for a predetermined time and then stopped so that the connection between the second input gear 320 and the first output gear 410 is smoothly released.

In a state in which the connection between the second connection gear 320 and the first output gear 410 is released, a user may manually close the door 20, and in a process in which the door 20 is manually closed, transmission of a closing force of the door 20 to the driver 110 may be blocked. Accordingly, after the automatic opening of the door 20, a phenomenon in which the driver 110 or gears are damaged during the process of the user manually closing the door 20 is prevented, and there is an advantage in that the door 20 can be smoothly closed.

After the automatic opening of the door 20 is completed and in a state in which the driver 110 is in a stopped state, for the automatic closing of the door 20, the controller 200 may cause the driver 110 to operate in a reverse direction when a closing command for the door 20 is detected or recognized, such as when a set time has elapsed after the door 20 is opened, when a user is not detected after the door 20 is opened, or when a separate door closing command is input. That is, the controller 200 may control the motor to rotate in a reverse direction.

When the motor is rotated in the reverse direction, as shown in FIG. 20, the second input gear 320 moves in a fourth direction due to stationary inertia, so that the second input gear 320 may be connected to the second output gear 420. The second input gear 320 may transmit power to the second output gear 420 in a horizontal direction. Therefore, a rotational direction of the second input gear 320 and a rotational direction of the second output gear 420 (or the output gear assembly) may be opposite to each other.

When the motor is rotated in the reverse direction, power of the motor is transmitted to the second transmission unit so that the second operating portion 180 may move from the door open position to the initial position in the door closing direction.

Since the connection between the fifth gear 130 and the transmission gear 140 is released during the process of opening the door 20, the first operating portion 170 and the transmission gear 140 maintain a stopped state while the motor is rotated in the reverse direction.

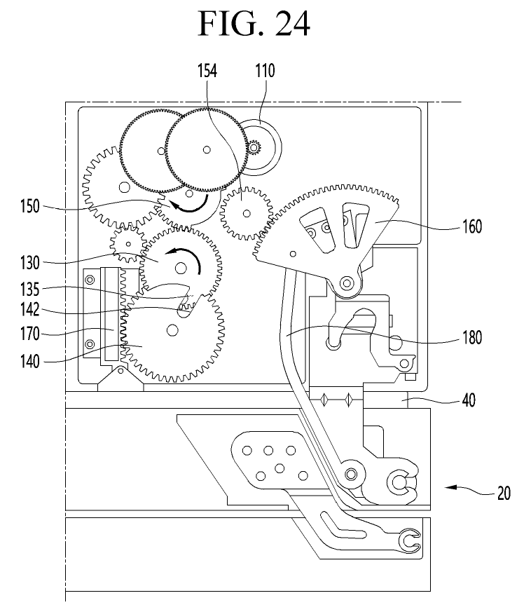

Referring to FIGS. 24 to 26D, during a process in which the motor is rotated in the reverse direction, the fifth gear 130 is rotated in the other direction.

During the process in which the fifth gear 130 is rotated in the other direction, the moving portion 135 may be aligned with the recess 143 as shown in FIG. 26A. When the fifth gear 130 is additionally rotated in the other direction, the moving portion 135 is in contact with the inclined surface 144 within the recess 143. Referring to FIGS. 26B and 26C, during the rotation of the fifth gear 130 in the other direction, the moving portion 135 is pressed by the inclined surface 144 and moves downward. When the moving portion 135 moves downward, the elastic member 148 may be contracted. Thereafter, referring to FIG. 26D, when the moving portion 135 is aligned with the slot 142, the elastic member 148 is extended, and the moving portion 135 is inserted into the slot 142 by an elastic force of the elastic member 148. The motor may be stopped at a point in time when the moving portion 135 is inserted into the slot 142 or after the moving portion 135 is inserted into the slot 142.

According to the present embodiment, at an initial stage of the automatic opening of the door, power of the motor is transmitted to the first operating portion and is used for separation of the gasket, and during or after a separation process of the gasket, the power is used as an opening force of the door. Therefore, there is an advantage in that the gasket of the door can be easily separated at the initial stage of the door opening.

Also, in the case of the present embodiment, the door is not only automatically opened but also automatically closed, so that convenience of a user is improved.

In addition, in the case of the present embodiment, when the driver is stopped after the door is automatically opened or while the driver is operating, power transmission to the driver is blocked by a clutch device. Accordingly, damage to the driver or gears is prevented during manual opening of the door, and there is an advantage in that the door can be smoothly closed.

### Process of Manually Opening the Door

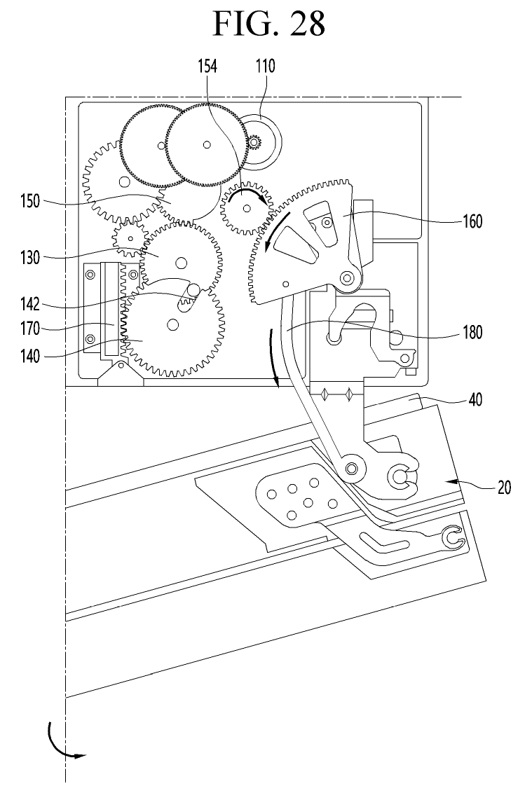

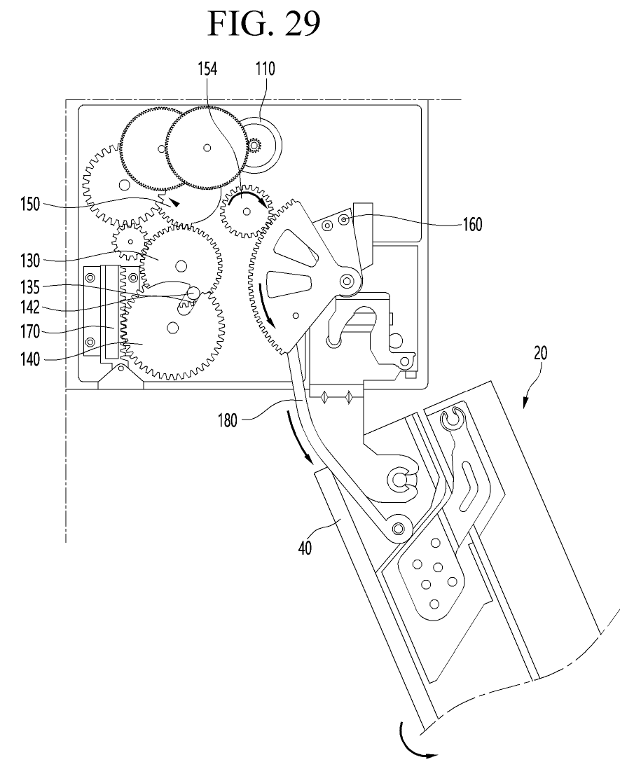

FIGS. 28 and 29 are drawings showing a process of manually opening a door.

Referring to FIGS. 28 and 29, a user may manually open the door 20 in a state in which the door 20 is closed.

As described above, in the state in which the door 20 is closed, the first transmission portion 150 and the second transmission portion 154 are in a disconnected state, so that rotation of the first transmission portion 150 is restricted even if the second transmission portion 154 is rotated. In the disconnected state of the first transmission portion 150 and the second transmission portion 154, the first transmission portion 150 may be located at a disconnected position.

When a user grips a handle of the door 20 and pulls the door 20, the door 20 may be rotated. When the door 20 is rotated in an opening direction, the second operating portion 180 connected to the door 20 moves together with the door 20. In the process of manually opening the door 20, the second operating portion 180 may move to a door open position by a rotational force of the door 20.

When the second operating portion 180 moves together with the door 20, the third transmission portion 160 connected to the second operating portion 180 is rotated. When the third transmission portion 160 is rotated, the second transmission portion 154 is also rotated. However, since the first transmission portion 150 is located at the disconnected position, the first transmission portion 150 is not rotated even if the second transmission portion 154 is rotated. Accordingly, in the process of manually opening the door 20, a manual rotational force of the door 20 is not transmitted to the first transmission portion 150. Since the rotational force of the door 20 is also not transmitted to the driver 110, applying a load to the driver 110 can be prevented. In addition, since the rotational force of the door 20 is not transmitted to the first transmission unit and the power transmission portion 120 during the manual opening process of the door 20, damage to gears can be prevented, and generation of noise due to rotation of the gears can be prevented.

Even in a process in which the user closes the door 20, the second transmission portion 154 rotates, but the first transmission portion 150 may maintain a stopped state.

Meanwhile, considering the weight of the door or the strength of magnetic force of a magnet, it is also possible to omit the first transmission unit and the first operating portion.

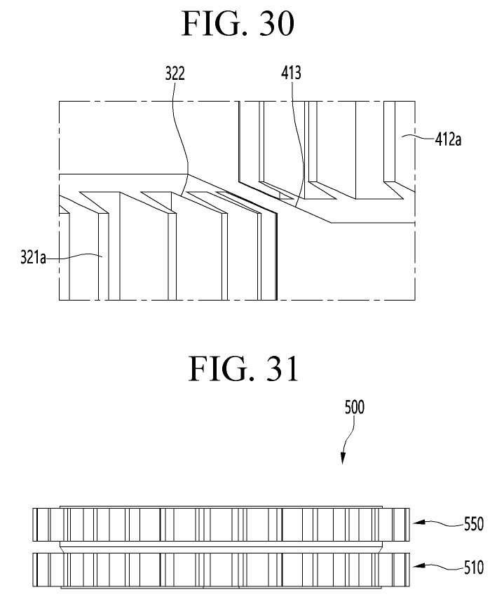

FIG. 30 is a view illustrating a second input gear and an output gear according to a second embodiment.

The present embodiment is identical to the first embodiment in other respects, except that it differs structures of the gear teeth of a second input gear and the gear teeth of an output gear. Therefore, hereinafter, only characteristic portions of the present embodiment will be described.

Referring to FIG. 30, in a case of the present embodiment, a gap between two adjacent gear teeth 321a of the second input gear may be increased for a smooth connection between a second input gear and an output gear. In addition, a gap between two adjacent gear teeth 412a of the output gear may be increased.

Although not limited, the gap between the two gear teeth 321a in the second input gear may be greater than a maximum width of each of the gear teeth 321a. The gap between the two gear teeth 412a in the output gear may be greater than a maximum width of each of the gear teeth 412a.

However, in order to enable power transmission between the second input gear and the output gear, a change in the length of the gear teeth may be considered in response to a change in the width of the gear teeth. That is, the gear teeth of the second input gear and the gear teeth of the output gear may be designed such that power transmission is possible while interference between the second input gear and the output gear is reduced.

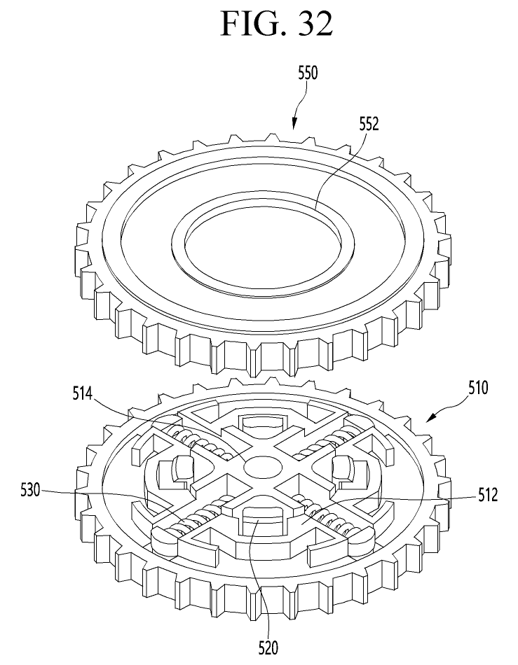

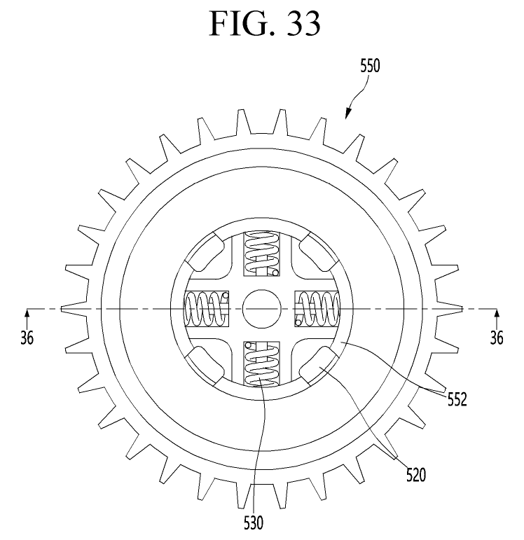

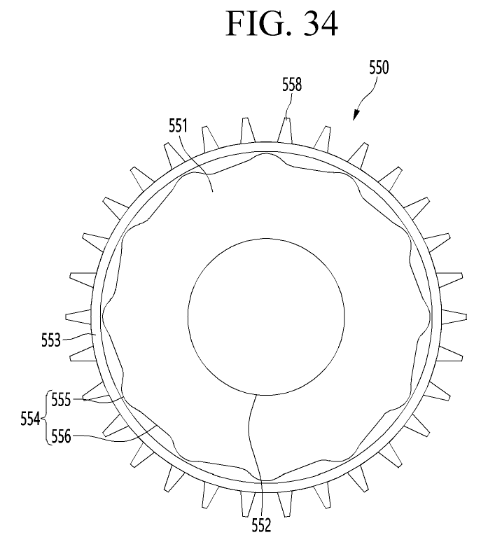

FIG. 31 is a side view of a second input gear according to a third embodiment. FIG. 32 is an exploded perspective view of a second input gear according to a third embodiment. FIG. 33 is a plan view of a second input gear according to a third embodiment. FIG. 34 is a plan view of a second gear portion according to a third embodiment.

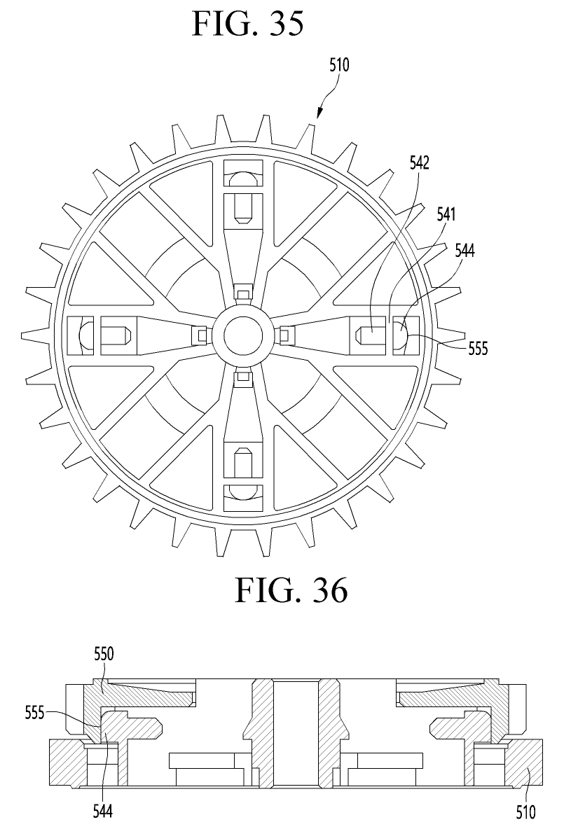

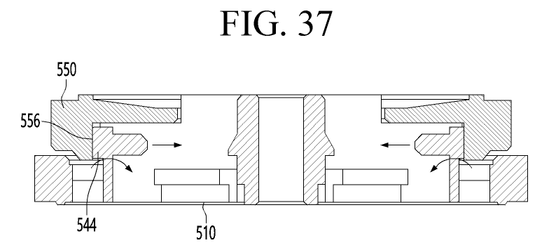

FIG. 35 is a bottom view of a second input gear according to a third embodiment. FIG. 36 is a cross-sectional view taken along line 36-36 of FIG. 33, illustrating a state in which a first gear portion and an output gear are normally coupled. FIG. 37 is a view illustrating a relative movement between a first gear portion and a second gear portion in a state where a first gear portion is interfered with an output gear.

The present embodiment is identical to the previous embodiments in other respects, except that it differs a structure of the second input gear. Therefore, hereinafter, only characteristic portions of the present embodiment will be described.

Referring to FIGS. 31 to 37, a second input gear 500 of the present embodiment may be designed to smoothly release interference when interference with the output gears 410 and 420 occurs, and to enable a smooth connection after the interference is released.

For example, the second input gear 500 may include a first gear portion 510 and a second gear portion 550 that are relatively movable.

The first gear portion 510 may be connected to the shaft 330 of the previous embodiment, and the second gear portion 550 may be relatively rotatably connected to the first gear portion 510. The second gear portion 550 may be connected to at least one of the first output gear 410 or the second output gear 420.

The first gear portion 510 may include a coupling body 512 protruding toward the second gear portion 550 at a central portion thereof. A coupling hole 514 for coupling the shaft 330 may be formed at the coupling body 512.

A hook 520 for coupling with the second gear portion 550 may be provided at a radially outer side of the coupling hole 514. The hook 520 may be coupled to the second gear portion 550 by passing through a hook hole 552 formed at a central portion of the second gear portion 550.

The hook 520 may protrude from the coupling body 512 toward the second gear portion 550. For example, a plurality of hooks 520 may be arranged to be spaced apart from each other along a circumference of the coupling hole 514.

The first gear portion 510 may include a plurality of elastic bodies 530. The plurality of elastic bodies 530 may be arranged to be spaced apart from each other along the circumference of the coupling hole 514. Each elastic body 530 may be, for example, a coil spring, and may be arranged to extend in a radial direction from the coupling hole 514.

The coupling body 512 may include a supporter 541. The supporter 541 may support the elastic body 530.

The supporter 541 may include a support protrusion 542 extending from the supporter 541 toward the coupling hole 514. The support protrusion 542 may be inserted into a space formed by the elastic body 530 to support the elastic body 530.

A portion around the supporter 541 in the first gear portion 510 may be formed by being cut away, so that the supporter 541 can be elastically deformed by an external force.

The supporter 541 may include a contact protrusion 544 extending from the supporter 541 in a direction away from the coupling hole 514. The contact protrusion 544 may be in contact with the second gear portion 550.

The second gear portion 550 may include a body 551 and an extension 553 extending from the body 551 toward the first gear portion 510.

The hook hole 552 may be formed at the body 551. A plurality of gear teeth 558 may be formed on an outer circumferential surface of the extension 553.

A cam portion 554 may be provided on an inner circumferential surface of the extension 553. The cam portion 554 may protrude from the extension 553 toward a central portion of the second gear portion 550.

The cam portion 554 may include concave portions 555 arranged to be spaced apart from each other, and a connection portion 556 connecting two adjacent concave portions 555. The connection portion 556 may include a straight portion or a curved portion. A distance between the connection portion 556 and the hook hole 552 may be less than a distance between the concave portion 555 and the hook hole 552.

In a state in which the first gear portion 510 and the second gear portion 550 are coupled, the contact protrusion 544 of the first gear portion 510 may be positioned in the concave portion 555. In a state where the contact protrusion 544 is positioned in the concave portion 555, the first gear portion 510 and the second gear portion 550 are rotatable together.

On the other hand, as shown in FIG. 37, in a state where the second gear portion 550 interferes with the output gears 410 and 420 while the second gear portion 550 is moving in an axial direction, the first gear portion 510 may be rotated relative to the second gear portion 550.

When the controller 200 determines that interference between the second gear portion 550 and the output gear is detected, the controller 200 may control the motor such that the motor performs forward rotation and reverse rotation one or more times. In this case, during the forward/reverse rotation of the second gear portion 550, the contact protrusion 544 may move from the concave portion 555 to the connection portion 556, and the supporter 541 may be elastically deformed.

In a process in which the elastically deformed supporter 541 returns to its original shape by the elastic body 530, the contact protrusion 544 may move to the original concave portion 555 or to an adjacent concave portion 555. In either case, in the process in which the elastically deformed supporter 541 returns to its original shape, the first gear portion 510 and the second gear portion 550 are relatively moved, and as the interference between the second gear portion 550 and the output gear is released, the second gear portion 550 and the output gear can be connected.

In the case of the present embodiment, depending on the positions or diameters of the first gear portion 510 and the second gear portion 550, only the second gear portion 550 may be connected to the first output gear 410 and the second output gear 420; or the second gear portion 550 may be connected to the first output gear 410 and the first gear portion 510 may be connected to the second output gear 420; or the first gear portion 510 may be connected to the first output gear 410 and the second gear portion 550 may be connected to the second output gear 420; or both the first gear portion 510 and the second gear portion 550 may be connected to the first output gear 410 and the second output gear 420.

On the other hand, although it has been described that the clutch device described above is applied to a refrigerator as an example, there is no limitation on products to which the clutch device is applied, and it is noted that the clutch device may be applied to various home appliances other than refrigerators. In addition, the clutch device may be applied to furniture other than home appliances.

Furthermore, although the clutch device has been described as being applied to a door opening/closing apparatus as an example, it may be variously applied to apparatuses that require transmission and release of power transmission.

What is claimed is:

1. A refrigerator comprising:
a cabinet having a storage space;
a door that opens and closes the storage space; and
a door opening and closing device to open and close the door,
wherein the door opening and closing device includes:
a driver that generates power,
a power transmission portion that transmits the power of the driver, and
an operating portion that receives the power of the driver and operates to open the door and including a link connected to the door,
wherein the power transmission portion includes:
an input gear assembly configured to receive power from the driver, and
an output gear assembly configured to be connected to the input gear assembly to receive power from the input gear assembly when the driver is operated, and to be disconnected from the input gear assembly when the driver is stopped, and
wherein a rotation center of the input gear assembly and a rotation center of the output gear assembly are spaced apart from each other.

2. The refrigerator of claim 1,
wherein the input gear assembly includes:
a shaft,
a first input gear connected to the shaft and the driver, and
a second input gear connected to the shaft, and
wherein the second input gear is moved in an axial direction of the shaft when the first input gear is rotated.

3. The refrigerator of claim 2,
wherein a rotational direction of the second input gear is opposite to a rotational direction of the output gear assembly.

4. The refrigerator of claim 2,
wherein the second input gear is located at an initial position when the driver is in a stopped state, and
wherein the second input gear is disconnected from the output gear assembly at the initial position of the second input gear.

5. The refrigerator of claim 4,
wherein the second input gear moves in one direction along the shaft due to stationary inertia when the driver is operated in a forward direction, and moves in another direction opposite to the one direction along the shaft when the driver is operated in a reverse direction.

6. The refrigerator of claim 5,
wherein the shaft includes a screw or a worm gear to allow movement of the second input gear.

7. The refrigerator of claim 6,
wherein the second input gear is directly coupled to the shaft, and a screw or a gear having a shape corresponding to the screw or the worm gear is formed on the second input gear.

8. The refrigerator of claim 6,
wherein the second input gear is connected to the shaft by a connection member, and
wherein a screw or a gear having a shape corresponding to the screw or the worm gear is formed on the connection member.

9. The refrigerator of claim 5,
wherein the input gear assembly further includes:
a first elastic member to restrict movement of the second input gear while the second input gear moves in the one direction when the driver is stopped during a reverse operation of the driver; and
a second elastic member to restrict movement of the second input gear while the second input gear moves in the other direction when the driver is stopped during a forward operation of the driver.

10. The refrigerator of claim 5,
wherein the output gear assembly includes:
a first output gear configured to be connected to the second input gear when the second input gear moves in the one direction; and
a second output gear configured to be connected to the second input gear when the second input gear moves in the other direction, and
wherein when the second input gear is at the initial position, the second input gear is disconnected from the first output gear and the second output gear.

11. The refrigerator of claim 10,
wherein the output gear assembly includes a connection portion connecting the first output gear and the second output gear, and
wherein the first output gear and the second output gear are rotated together.

12. The refrigerator of claim 10,
wherein the second input gear includes a plurality of gear teeth,
wherein a first inclined surface is formed on a portion of each of the gear teeth facing the first output gear, and
wherein a second inclined surface is formed on a portion of each of the gear teeth facing the second output gear.

13. The refrigerator of claim 12,
wherein an inclined surface is formed on a portion of each of the gear teeth of the first output gear facing the first inclined surface, and
wherein an inclined surface is formed on a portion of each of the gear teeth of the second output gear facing the second inclined surface.

14. The refrigerator of claim 2,
wherein the second input gear includes:
a first gear portion connected to the shaft, and
a second gear portion connected to the first gear portion and configured to be rotatable relative to the first gear portion.

15. The refrigerator of claim 1,
wherein the operating portion includes:
a first operating portion that operates by receiving the power from the driver, and
a second operating portion that operates by receiving the power from the driver from the output gear assembly and including the link, and
wherein, when the driver operates to automatically open the door, the first operating portion starts to operate, and the second operating portion starts to operate after the first operating portion starts to operate.

16. A door opening and closing device for opening and closing a door comprising:
a driver that generates power;
a power transmission portion that transmits the power of the driver;
an operating portion that receives the power of the driver and operates to open the door;
a first operating portion that operates by receiving power from the driver; and
a second operating portion configured to operate by receiving power from the driver and having a link connected to the door,
wherein the power transmission portion includes: an input gear assembly, and an output gear assembly to receive power from the input gear assembly and transmit the power to the second operating portion,
wherein the input gear assembly includes:
a shaft,
a first input gear connected to the shaft, and
a second input gear located at an initial position when the driver is in a stopped state, and configured to move to be connected to the output gear assembly when the driver is operated, and
wherein the input gear assembly is configured to transmit power to the output gear assembly in a direction crossing an axial direction of the shaft.

17. The door opening and closing device of claim 16,
wherein the second input gear moves in the axial direction of the shaft wherein the first input gear is rotated.

18. The door opening and closing device of claim 17,
wherein the output gear assembly includes:
a first output gear configured to be connected to the second input gear when the driver is operated in a forward direction; and
a second output gear configured to be connected to the second input gear when the driver is operated in a reverse direction.

19. The door opening and closing device of claim 18,
wherein the first output gear and the second output gear rotate in a direction opposite to a rotational direction of the second input gear, and the first output gear and the second output gear rotate together in the same direction.

20. The door opening and closing device of claim 18,
wherein the input gear assembly may further include:
a first elastic member to restrict movement of the second input gear while the second input gear moves in one direction when the driver is stopped during a reverse operation of the driver; and
a second elastic member to restrict movement of the second input gear while the second input gear moves in the other direction when the driver is stopped during a forward operation of the driver.
